(19) United States
(12) Patent Application Publication
(10) Pub. No.: US 2014/0240210 A1
(43) Pub. Date: Aug. 28, 2014

(54) ELECTROPHORETIC DISPLAY AND METHOD OF DRIVING AN ELECTROPHORETIC DISPLAY

(71) Applicant: SiPix Technology, Inc., Taoyuan (TW)

(72) Inventors: Yan-Liang Wu, Kaohsiung City (TW); Chi-Mao Hung, Hsinchu City (TW); Wei-Min Sun, Taipei City (TW); Pei-Lin Tien, Taichung City (TW); Chih-Yuan Hsu, Taipei City (TW); Hsiao-Lung Cheng, Taoyuan County (TW)

(73) Assignee: SiPix Technology, Inc., Taoyuan (TW)

(21) Appl. No.: 14/164,241

(22) Filed: Jan. 26, 2014

(30) Foreign Application Priority Data
Feb. 25, 2013 (TW) 102106550

(51) Int. Cl. G09G 3/34

(52) U.S. Cl. CPC G09G 3/344
USPC 345/107

(57) ABSTRACT

An electrophoretic display includes a data driving circuit, a plurality of first electrodes, a gate driving circuit, a plurality of second electrodes and an electrophoretic layer. The data driving circuit is used for generating data signals. The first electrodes are used for receiving the data signals transmitted from the data driving circuit. The gate driving circuit is used for generating gate signals. The second electrodes are used for receiving the gate signals transmitted from the gate driving circuit. The electrophoretic layer is disposed between the plurality of first electrodes and the plurality of second electrodes. The gate driving circuit drives the second electrodes with a non-adjacent sequence.

### BACKGROUND OF THE INVENTION

1. Field of the Invention

The present invention related to an electrophoretic display and a method of driving an electrophoretic display, and particularly to an electrophoretic display and a method of driving an electrophoretic display that can drive nonadjacent electrodes in turn.

2. Description of the Prior Art

Because a flat panel display has advantages of light, thin, low power consumption, no radiation, and so on, the flat panel display can be widely applied to computer screens, mobile phones, personal digital assistants, flat-screen televisions, and so on. Recently, display manufacturers further develops electrophoretic displays (called electronic paper) to further provide lighter, thinner, and flexible and portable displays, and the electronic paper can maintain previously displayed pictures and words without external applied voltages. Generally speaking, an electrophoretic display includes a gate driving circuit, a data driving circuit, and a plurality of pixels. The gate driving circuit is used for providing a plurality of gate signals, and the data driving circuit is used for providing a plurality of data signals. Each pixel of the electrophoretic display has a data switch, an electrophoretic medium, and a plurality of charged particles suspending in the electrophoretic medium, where colors of the plurality of charged particles are different from a color of the electrophoretic medium. The data switch controls writing operation of data signals according to the gate signals, where the data signals can change a voltage drop between two sides of the electrophoretic medium to adjust suspended positions of the plurality of charged particles in the electrophoretic medium. Thus, the electrophoretic display can display gray levels corresponding to the data signals by color contrast between the plurality of charged particles and the electrophoretic medium.

In the prior art, when the plurality of pixels of the electrophoretic display are driven by the gate signals, the gate driving circuit drives the plurality of pixels from a first pixel row to a last pixel row in turn, or from the last pixel row to the first pixel row in turn. However, coupling voltages will be generated between the plurality of pixels, resulting in electrophoretic display performance be influenced and further decreasing reliability and life time of the electrophoretic display.

### SUMMARY OF THE INVENTION

An embodiment provides an electrophoretic display. The electrophoretic display includes a data driving circuit, a plurality of first electrodes, a gate driving circuit, a plurality of second electrodes, and an electrophoretic layer. The data driving circuit is used for generating data signals. The plurality of first electrode are arranged along a first axis direction and coupled to the data driving circuit for receiving the data signals transmitted from the data driving circuit. The gate driving circuit is used for generating gate signals. The plurality of second electrodes are arranged along a second axis direction different from the first axis direction, where the plurality of second electrodes are disposed a same side as the plurality of first electrodes and coupled to the gate driving circuit for receiving the gate signals transmitted from the gate driving circuit. The electrophoretic layer is disposed between the plurality of first electrodes and the plurality of second electrodes. The gate driving circuit drives nonadjacent second electrodes of the plurality of second electrodes in turn.

Another embodiment provides a method of driving an electrophoretic display, where the electrophoretic display includes a plurality of first electrodes, a plurality of second electrodes, and an electrophoretic layer, and the electrophoretic layer is disposed between the plurality of first electrodes and the plurality of second electrodes. The method includes the gate driving circuit outputting a first gate signal to a second electrode of the plurality of second electrodes; the data driving circuit outputting first data signals to the plurality of first electrodes to make the electrophoretic layer generate first image signals accordingly when the gate driving circuit output the first gate signal to the second electrode; the gate driving circuit outputting a second gate signal to another second electrode of the plurality of second electrodes, wherein the another second electrode is nonadjacent to the second electrode; and the data driving circuit outputting second data signals to the plurality of first electrodes to make the electrophoretic layer generate second image signals accordingly when the gate driving circuit outputs the second gate signal to the another second electrode output gate signals. During a frame period, the gate driving circuit outputs the second gate signal to the another second electrode after the gate driving circuit outputs the first gate signal to the second electrode output and the gate driving circuit does not yet output gate signals to other second electrodes of the plurality of second electrodes.

In the present invention, a gate driving circuit first drives odd electrodes rows of an electrophoretic display in turn and then drives even electrodes rows of the electrophoretic display in turn, or first drives the even electrodes rows of the electrophoretic display in turn and then drives the odd electrodes rows of the electrophoretic display in turn, instead of sequentially driving the plurality of electrodes of the electrophoretic display. Therefore, the present invention not only can significantly reduce coupling voltages between pixels of the electrophoretic display, but can also increase reliability and life time of the electrophoretic display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electrophoretic display according to an embodiment.

FIG. 2 is a diagram illustrating a plurality of second electrodes of the electrophoretic display 100 in FIG. 1.

FIG. 3A and FIG. 3B are flowcharts illustrating operation of the electrophoretic display in FIG. 1 according to another embodiment.

FIG. 4A and FIG. 4B are flowcharts illustrating operation of the electrophoretic display in FIG. 1 according to another embodiment.

### DETAILED DESCRIPTION

The detailed descriptions of the present invention are exemplified below in examples. However, the examples are merely used to illustrate the present invention, not to limit the present invention. Because one skilled in the art may modify the present invention or combine the present invention with some features within the scope of the present invention, the claimed scope of the present invention should be referred to in the following claims. In the present specification and claims, the term “comprising” is open type and should not be viewed as the term “consisted of.” Besides, the term “electrically coupled” can be referring to either directly connecting or indirectly connecting between elements. Thus, if it is described in the below contents of the present invention that a first device is electrically coupled to a second device, the first device can be directly connected to the second device, or indirectly connected to the second device through other devices or means.

The embodiments and figures are provided as follows in order to illustrate the present invention in detail, but the claimed scope of the present invention is not limited by the provided embodiments and figures. Further, the numbers of steps performed in the methods of the present invention are not used to limit the priority of performing steps of the present invention. Any methods formed by recombining the steps of the present invention belong to the scope of the present invention.

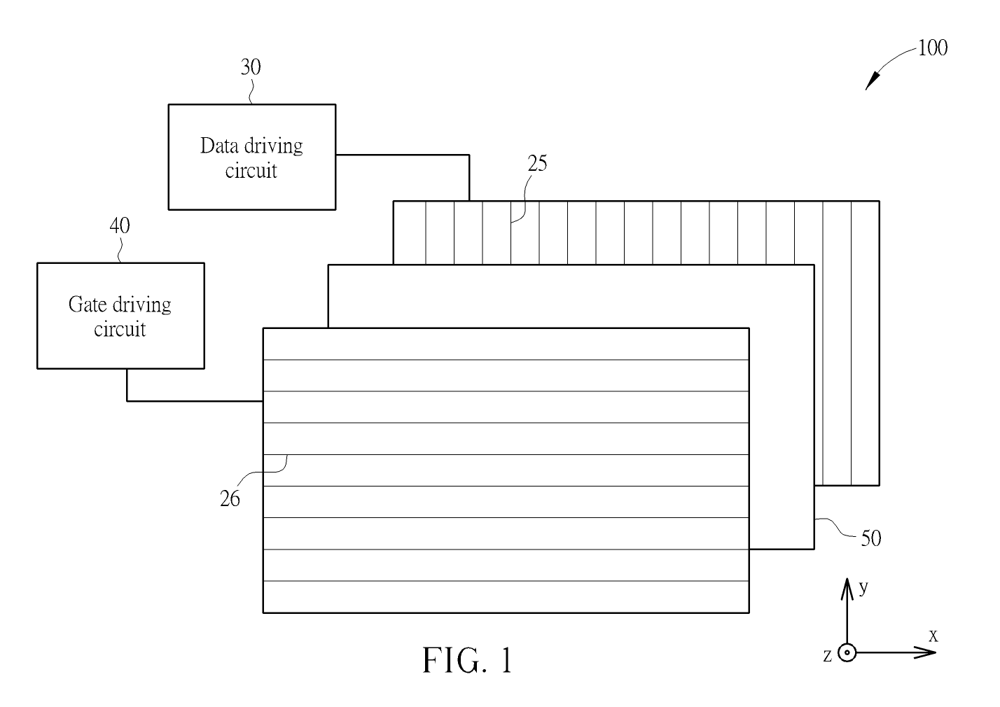

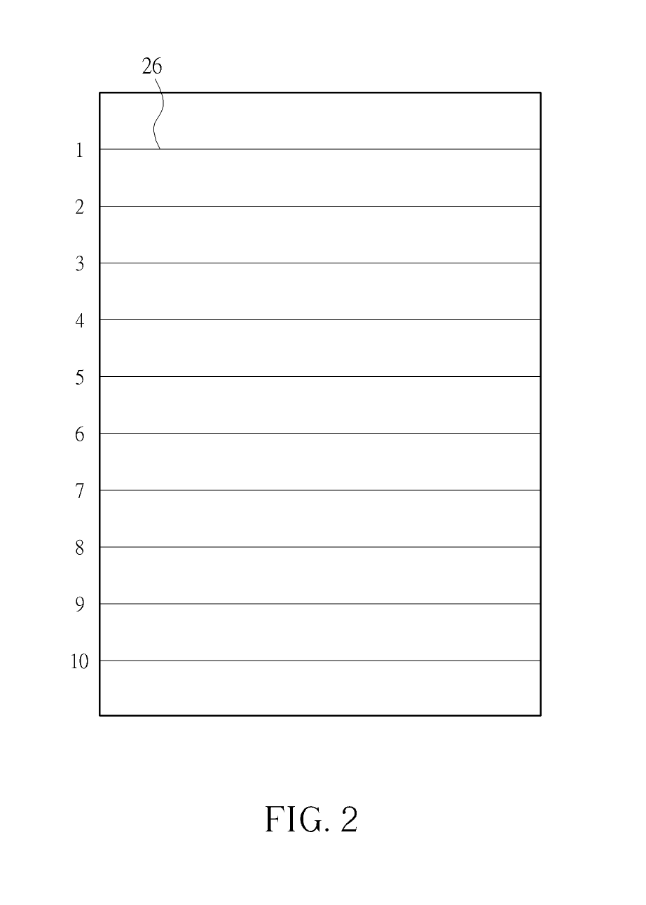

Please refer to FIG. 1 and FIG. 2. FIG. 1 is a diagram illustrating an electrophoretic display 100 according to an embodiment, and FIG. 2 is a diagram illustrating a plurality of second electrodes 26 of the electrophoretic display 100 in FIG. 1. As shown in FIG. 1, the electrophoretic display 100 includes a data driving circuit 30, a plurality of first electrodes 25, a gate driving circuit 40, the plurality of second electrodes 26, and an electrophoretic layer 50. The data driving circuit 30 is used for generating data signals. The plurality of first electrodes 25 are arranged along a y axis direction and coupled to the data driving circuit 30, where the plurality of first electrodes 25 are used for receiving the data signals transmitted from the data driving circuit 30. The gate driving circuit 40 is used for generating gate signals. The plurality of second electrodes 26 are arranged along an x axis direction, where the plurality of second electrodes 26 are disposed a same side as the plurality of first electrodes 25 and coupled to the gate driving circuit 40, and the plurality of second electrodes 26 are used for receiving the gate signals transmitted from the gate driving circuit 40. The electrophoretic layer 50 is disposed between the plurality of first electrodes 25 and the plurality of second electrodes 26. That is to say, the plurality of first electrodes 25, the electrophoretic layer 50, and the plurality of second electrodes 26 are arranged along a z axis direction in turn. The gate driving circuit 40 drives nonadjacent second electrodes of the plurality of second electrodes 26 in turn according to the gate signals thereof.

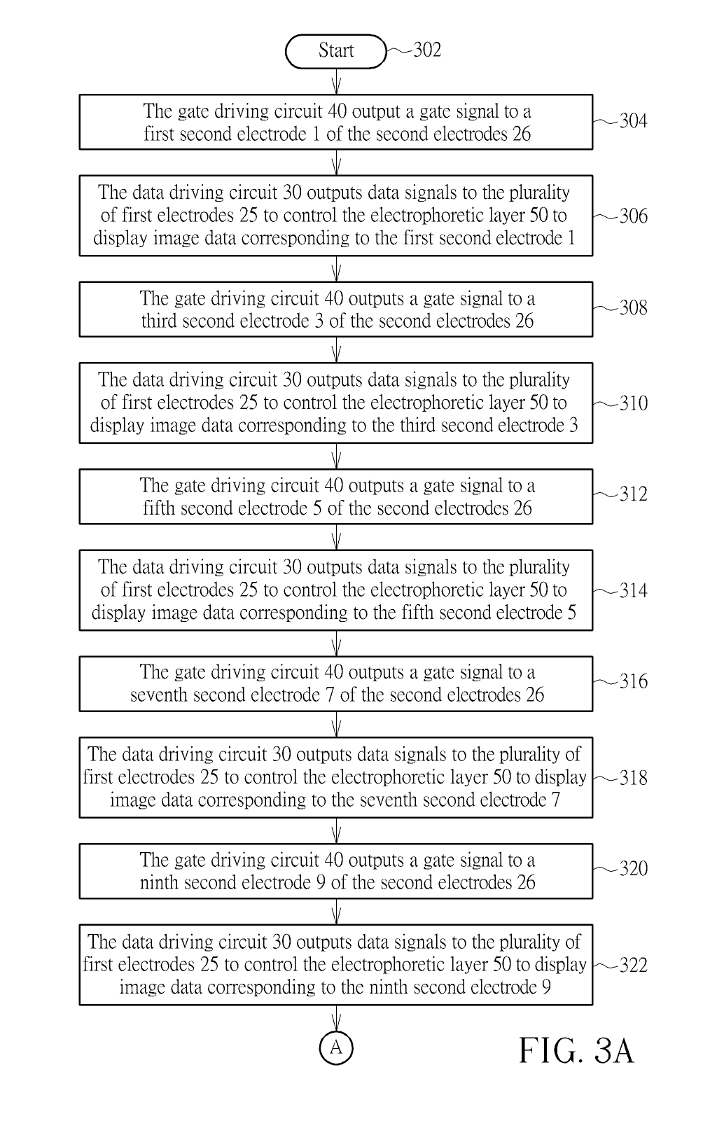

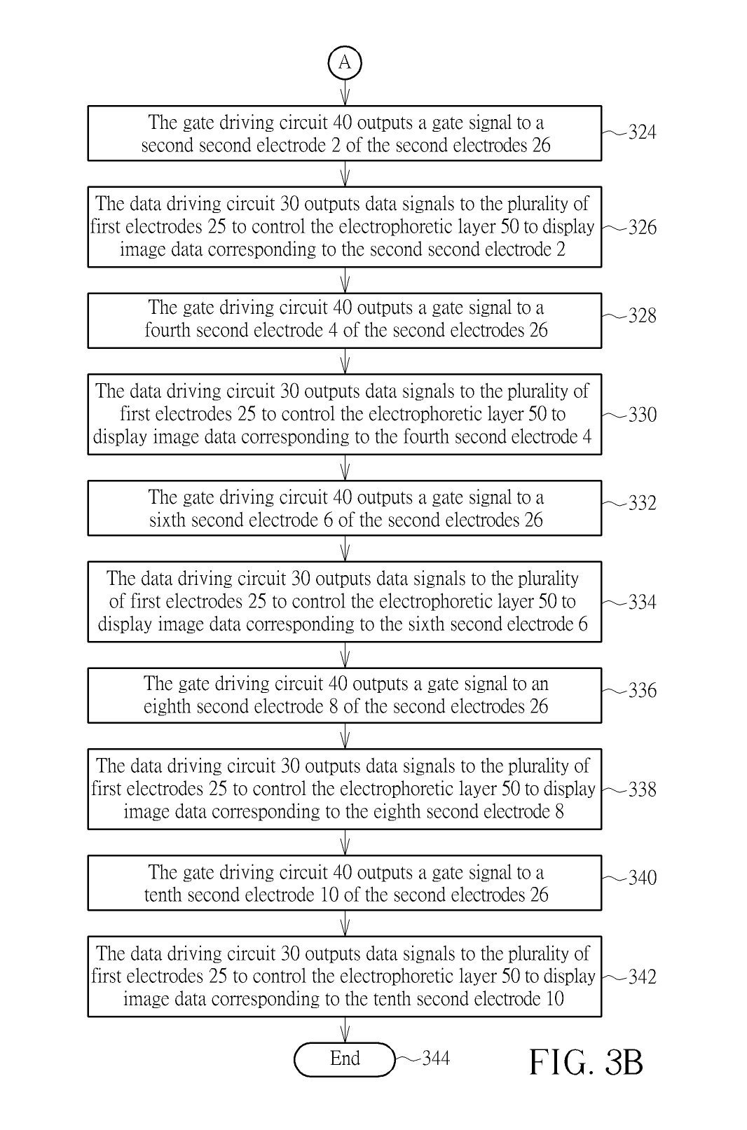

Please refer to FIG. 3A and FIG. 3B. FIG. 3A and FIG. 3B are flowcharts illustrating operation of the electrophoretic display 100 in FIG. 1 according to another embodiment. In FIG. 3A and FIG. 3B, take the electrophoretic display 100 with ten second electrodes 26 as an example. Detailed steps are as follows:

Step 302: Start.

Step 304: The gate driving circuit 40 output a gate signal to a first second electrode 1 of the second electrodes 26.

Step 306: After Step 304 is executed, the data driving circuit 30 outputs data signals to the plurality of first electrodes 25 to control the electrophoretic layer 50 to display image data corresponding to the first second electrode 1.

Step 308: After Step 306 is executed, the gate driving circuit 40 outputs a gate signal to a third second electrode 3 of the second electrodes 26.

Step 310: After Step 308 is executed, the data driving circuit 30 outputs data signals to the plurality of first electrodes 25 to control the electrophoretic layer 50 to display image data corresponding to the third second electrode 3.

Step 312: After Step 310 is executed, the gate driving circuit 40 outputs a gate signal to a fifth second electrode 5 of the second electrodes 26.

Step 314: After Step 312 is executed, the data driving circuit 30 outputs data signals to the plurality of first electrodes 25 to control the electrophoretic layer 50 to display image data corresponding to the fifth second electrode 5.

Step 316: After Step 314 is executed, the gate driving circuit 40 outputs a gate signal to a seventh second electrode 7 of the second electrodes 26.

Step 318: After Step 316 is executed, the data driving circuit 30 outputs data signals to the plurality of first electrodes 25 to control the electrophoretic layer 50 to display image data corresponding to the seventh second electrode 7.

Step 320: After Step 318 is executed, the gate driving circuit 40 outputs a gate signal to a ninth second electrode 9 of the second electrodes 26.

Step 322: After Step 320 is executed, the data driving circuit 30 outputs data signals to the plurality of first electrodes 25 to control the electrophoretic layer 50 to display image data corresponding to the ninth second electrode 9.

Step 324: After Step 322 is executed, the gate driving circuit 40 outputs a gate signal to a second second electrode 2 of the second electrodes 26.

Step 326: After Step 324 is executed, the data driving circuit 30 outputs data signals to the plurality of first electrodes 25 to control the electrophoretic layer 50 to display image data corresponding to the second second electrode 2.

Step 328: After Step 326 is executed, the gate driving circuit 40 outputs a gate signal to a fourth second electrode 4 of the second electrodes 26.

Step 330: After Step 328 is executed, the data driving circuit 30 outputs data signals to the plurality of first electrodes 25 to control the electrophoretic layer 50 to display image data corresponding to the fourth second electrode 4.

Step 332: After Step 330 is executed, the gate driving circuit 40 outputs a gate signal to a sixth second electrode 6 of the second electrodes 26.

Step 334: After Step 332 is executed, the data driving circuit 30 outputs data signals to the plurality of first electrodes 25 to control the electrophoretic layer 50 to display image data corresponding to the sixth second electrode 6.

Step 336: After Step 334 is executed, the gate driving circuit 40 outputs a gate signal to an eighth second electrode 8 of the second electrodes 26.

Step 338: After Step 336 is executed, the data driving circuit 30 outputs data signals to the plurality of first electrodes 25 to control the electrophoretic layer 50 to display image data corresponding to the eighth second electrode 8.

Step 340: After Step 338 is executed, the gate driving circuit 40 outputs a gate signal to a tenth second electrode 10 of the second electrodes 26.

Step 342: After Step 340 is executed, the data driving circuit 30 outputs data signals to the plurality of first electrodes 25 to control the electrophoretic layer 50 to display image data corresponding to the tenth second electrode 10.

Step 344: End.

According to Step 300 to Step 344, during a frame period, after the gate driving circuit 40 first outputs the gate signals to the first second electrode 1, the third second electrode 3, the fifth second electrode 5, the seventh second electrode 7, and the ninth second electrode 9 in turn, the gate driving circuit 40 starts to output the gate signal to the second second electrode 2, instead of immediately outputting the gate signal (corresponding to the second second electrode 2) to the second second electrode 2 after the gate driving circuit 40 output the gate signal (corresponding to the first second electrode 1) to the first second electrode 1. That is to say, the gate driving circuit 40 first drives the second electrodes 1, 3, 5, 7, 9 in turn, and then drives the second electrodes 2, 4, 6, 8, 10 in turn. Therefore, the gate driving circuit 40 drives the second electrodes 1, 3, 5, 7, 9, 2, 4, 6, 8, 10 in turn, not driving the second electrodes 1, 2, 3, 4, 5, 6, 7, 8, 9, 10. Thus, the embodiment in FIG. 3A and FIG. 3B can generate spatial dithering effect. Compared to a method of an electrophoretic display sequentially driving electrodes in the prior art, the embodiment in FIG. 3A and FIG. 3B not only can significantly reduce coupling voltages between pixels of the electrophoretic display 100, but can also increase reliability and life time of the electrophoretic display 100.

Further, in another embodiment of the present invention, the gate driving circuit 40 can first drive the second electrodes 2, 4, 6, 8, 10, and then drive the second electrodes 1, 3, 5, 7, 9. In addition, the present invention is not limited to the electrophoretic display 100 including ten second electrodes 26. That is to say, the electrophoretic display 100 can include more or less second electrodes. In addition, any configuration in which the gate driving circuit 40 utilizes non-sequential driving adjacent electrode method to operate an electrophoretic display or other types display falls within the scope of the present invention.

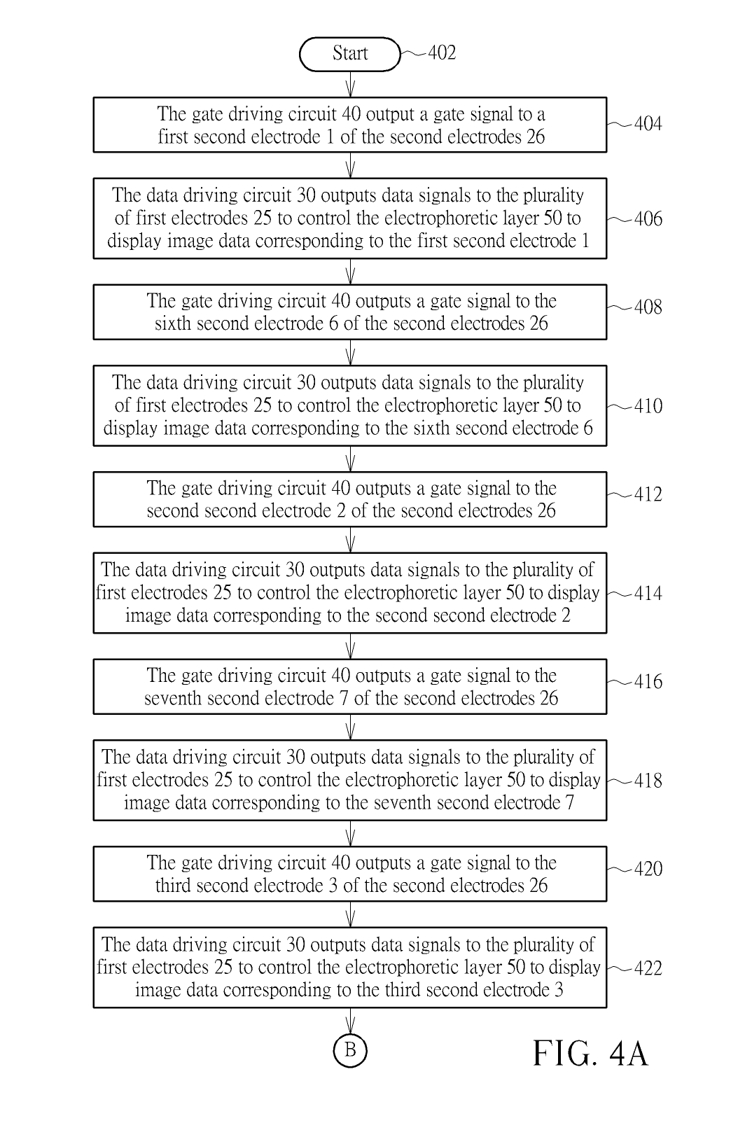

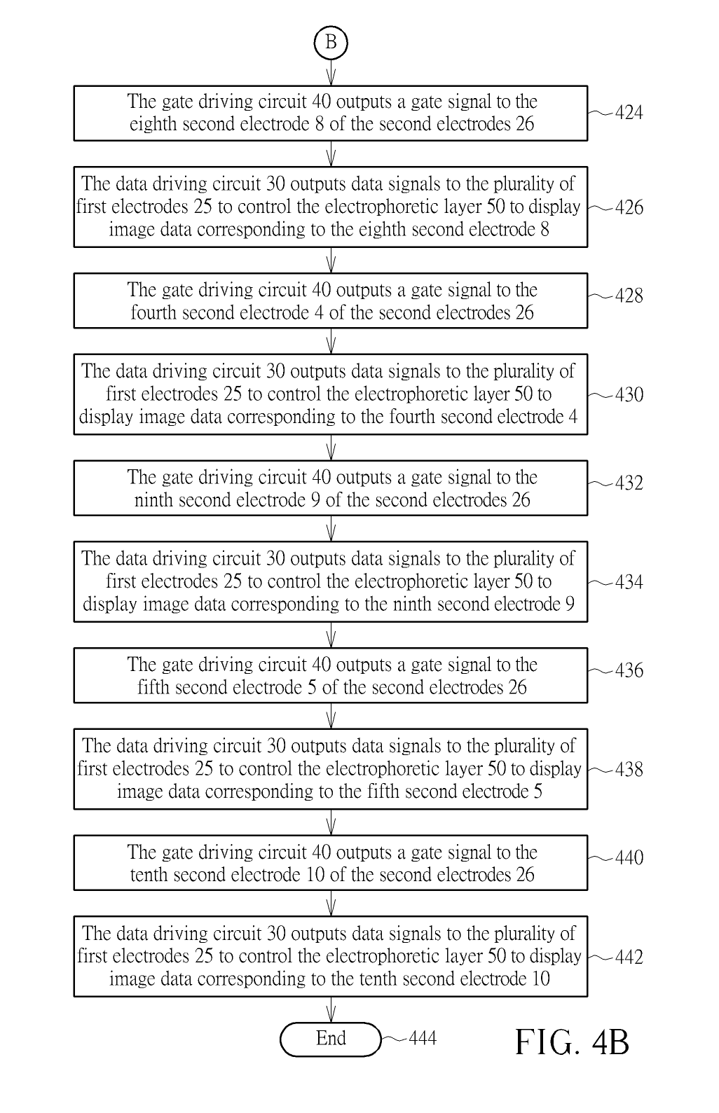

Please refer to FIG. 4A and FIG. 4B. FIG. 4A and FIG. 4B are flowcharts illustrating operation of the electrophoretic display 100 in FIG. 1 according to another embodiment. Similarly, also take the electrophoretic display 100 with ten second electrodes 26 as an example in FIG. 4A and FIG. 4B. Detailed steps are as follows:

Step 402: Start.

Step 404: The gate driving circuit 40 output a gate signal to a first second electrode 1 of the second electrodes 26.

Step 406: After Step 404 is executed, the data driving circuit 30 outputs data signals to the plurality of first electrodes 25 to control the electrophoretic layer 50 to display image data corresponding to the first second electrode 1.

Step 408: After Step 406 is executed, the gate driving circuit 40 outputs a gate signal to the sixth second electrode 6 of the second electrodes 26.

Step 410: After Step 408 is executed, the data driving circuit 30 outputs data signals to the plurality of first electrodes 25 to control the electrophoretic layer 50 to display image data corresponding to the sixth second electrode 6.

Step 412: After Step 410 is executed, the gate driving circuit 40 outputs a gate signal to the second second electrode 2 of the second electrodes 26.

Step 414: After Step 412 is executed, the data driving circuit 30 outputs data signals to the plurality of first electrodes 25 to control the electrophoretic layer 50 to display image data corresponding to the second second electrode 2.

Step 416: After Step 414 is executed, the gate driving circuit 40 outputs a gate signal to the seventh second electrode 7 of the second electrodes 26.

Step 418: After Step 416 is executed, the data driving circuit 30 outputs data signals to the plurality of first electrodes 25 to control the electrophoretic layer 50 to display image data corresponding to the seventh second electrode 7.

Step 420: After Step 418 is executed, the gate driving circuit 40 outputs a gate signal to the third second electrode 3 of the second electrodes 26.

Step 422: After Step 420 is executed, the data driving circuit 30 outputs data signals to the plurality of first electrodes 25 to control the electrophoretic layer 50 to display image data corresponding to the third second electrode 3.

Step 424: After Step 422 is executed, the gate driving circuit 40 outputs a gate signal to the eighth second electrode 8 of the second electrodes 26.

Step 426: After Step 424 is executed, the data driving circuit 30 outputs data signals to the plurality of first electrodes 25 to control the electrophoretic layer 50 to display image data corresponding to the eighth second electrode 8.

Step 428: After Step 426 is executed, the gate driving circuit 40 outputs a gate signal to the fourth second electrode 4 of the second electrodes 26.

Step 430: After Step 428 is executed, the data driving circuit 30 outputs data signals to the plurality of first electrodes 25 to control the electrophoretic layer 50 to display image data corresponding to the fourth second electrode 4.

Step 432: After Step 430 is executed, the gate driving circuit 40 outputs a gate signal to the ninth second electrode 9 of the second electrodes 26.

Step 434: After Step 432 is executed, the data driving circuit 30 outputs data signals to the plurality of first electrodes 25 to control the electrophoretic layer 50 to display image data corresponding to the ninth second electrode 9.

Step 436: After Step 434 is executed, the gate driving circuit 40 outputs a gate signal to the fifth second electrode 5 of the second electrodes 26.

Step 438: After Step 436 is executed, the data driving circuit 30 outputs data signals to the plurality of first electrodes 25 to control the electrophoretic layer 50 to display image data corresponding to the fifth second electrode 5.

Step 440: After Step 438 is executed, the gate driving circuit 40 outputs a gate signal to the tenth second electrode 10 of the second electrodes 26.

Step 442: After Step 440 is executed, the data driving circuit 30 outputs data signals to the plurality of first electrodes 25 to control the electrophoretic layer 50 to display image data corresponding to the tenth second electrode 10.

Step 444: End.

In the embodiment of FIG. 4A and FIG. 4B, the second electrodes 1 to 5 of the second electrodes 26 belong to a block, and the second electrodes 6 to 10 of the second electrodes 26 belong to another block. It is noted that the gate driving circuit 40 drives the second electrodes of the two blocks alternately. Therefore, during a frame period, after the gate driving circuit 40 outputs the gate signal corresponding to the first second electrode 1 to the first second electrode 1, the gate driving circuit 40 outputs the gate signal corresponding to the sixth second electrode 6 to the sixth second electrode 6 belonging to different block; and after the gate driving circuit 40 outputs the gate signal corresponding to the sixth second electrode 6 the sixth second electrode 6, the gate driving circuit 40 outputs the gate signal corresponding to the third second electrode 3 to the third second electrode 3 belonging to different block; and so on. That is to say, the gate driving circuit 40 does not immediately output the gate signal corresponding to the second second electrode 2 after gate driving circuit 40 outputs the gate signal corresponding to the first second electrode 1. That is to say, the gate driving circuit 40 drives the second electrodes 1, 6, 2, 7, 3, 8, 4, 9, 5, 10 in turn, instead of driving the second electrodes 1, 2, 3, 4, 5, 6, 7, 8, 9, 10 in turn. Therefore, the embodiment in FIG. 4A and FIG. 4B can generate spatial dithering effect. Compared to a method of an electrophoretic display sequentially driving electrodes in the prior art, the embodiment in FIG. 3A and FIG. 3B not only can significantly reduce coupling voltages between pixels of the electrophoretic display 100, but can also increase reliability and life time of the electrophoretic display 100.

Further, in another embodiment of the present invention, the gate driving circuit 40 can first the sixth second electrode 6, and then drive the first second electrode 1. Thus, in another embodiment of the present invention, a sequence of the gate driving circuit 40 driving the second electrodes 1, 6, 2, 7, 3, 8, 4, 9, 5, 10 in turn is changed to a sequence of the gate driving circuit 40 driving the second electrodes 6, 1, 7, 2, 8, 3, 9, 4, 10, 5 in turn. In addition, the present invention is not limited to the electrophoretic display 100 including ten second electrodes 26, or the second electrodes 26 of the electrophoretic display 100 being divided into two blocks. That is to say, the electrophoretic display 100 can include more or less second electrodes, or be divided into more blocks. In addition, any configuration in which the gate driving circuit 40 utilizes non-sequential driving adjacent electrode method to operate an electrophoretic display or other types display falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrophoretic display, comprising:
a data driving circuit for generating data signals;
a plurality of first electrodes arranged along a first axis direction and coupled to the data driving circuit for receiving the data signals transmitted from the data driving circuit;
a gate driving circuit for generating gate signals;
a plurality of second electrodes arranged along a second axis direction different from the first axis direction, wherein the plurality of second electrodes are disposed a same side as the plurality of first electrodes and coupled to the gate driving circuit for receiving the gate signals transmitted from the gate driving circuit; and
an electrophoretic layer disposed between the plurality of first electrodes and the plurality of second electrodes;
wherein the gate driving circuit drives nonadjacent second electrodes of the plurality of second electrodes in turn.

2. The electrophoretic display of claim 1, wherein the first axis direction is perpendicular to the second axis direction.

3. The electrophoretic display of claim 1, wherein the gate driving circuit first drives odd electrodes of the plurality of second electrodes in turn, and then drives even electrodes of the plurality of second electrodes in turn.

4. The electrophoretic display of claim 1, wherein the gate driving circuit first drives even electrodes of the plurality of second electrodes in turn, and then drives odd electrodes of the plurality of second electrodes in turn.

5. The electrophoretic display of claim 1, wherein the plurality of second electrodes comprise second electrodes belonging to a first block and second electrodes belonging to a second block, the first block is adjacent to the second block, and the gate driving circuit alternately drives the second electrodes belonging to the first block and the second electrodes belonging to the second block in turn.

6. A method of driving an electrophoretic display, wherein the electrophoretic display comprises a data driving circuit, a plurality of first electrodes, a gate driving circuit, a plurality of second electrodes, and an electrophoretic layer, and the electrophoretic layer is disposed between the plurality of first electrodes and the plurality of second electrodes, the method comprising:
the gate driving circuit outputting a first gate signal to a second electrode of the plurality of second electrodes;
the data driving circuit outputting first data signals to the plurality of first electrodes to make the electrophoretic layer generate first image signals accordingly when the gate driving circuit output the first gate signal to the second electrode;
the gate driving circuit outputting a second gate signal to another second electrode of the plurality of second electrodes, wherein the another second electrode is nonadjacent to the second electrode; and
the data driving circuit outputting second data signals to the plurality of first electrodes to make the electrophoretic layer generate second image signals accordingly when the gate driving circuit outputs the second gate signal to the another second electrode output gate signals;
wherein during a frame period, the gate driving circuit outputs the second gate signal to the another second electrode after the gate driving circuit outputs the first gate signal to the second electrode output and the gate driving circuit does not yet output gate signals to other second electrodes of the plurality of second electrodes.

7. The method of claim 6, wherein the second electrode and the another second electrode are odd electrodes of the plurality of second electrodes.

8. The method of claim 6, wherein the second electrode and the another second electrode are even electrodes of the plurality of second electrodes.

9. The method of claim 6, wherein the second electrode and the another second electrode belong to different blocks of the plurality of second electrodes, respectively.
